(19) United States
(12) Patent Application Publication
(10) Pub. No.: US 2004/0009269 A1
(43) Pub. Date: Jan. 15, 2004

(54) Method and apparatus for extending shelf-life and prevention of discoloration of meat products

(76) Inventor: Gaurav Tewari, San Antonio, TX (US)

Correspondence Address: Gaurav Tewari, 12701 West Avenue, Apt # 1622, San Antonio, TX, 78216, US

(21) Appl. No.: 10/192,916

(22) Filed: Jul. 9, 2002

Related U.S. Application Data
(60) Provisional application No. 60/303,985, filed on Jul. 9, 2001.

(51) Int. Cl. C12C 1/027

(52) U.S. Cl. 426/263; 426/106; 426/232

(57) ABSTRACT

A packaging system and method of the same designed to extend the shelf-life of meat cuts operatively positioned onto a tray. One or more trays is wrapped in a permeable film and is/are inserted into a master bag filled with a gas, namely nitrogen. The packaging system has a storage life of at least ten weeks and a display life of at least three days.

Specifically, the method of extending shelf-life of meat includes where at least one meat cut is placed onto the tray and the film is sealed over the tray. The master bag is filled with nitrogen gas and the tray(s) is/are introduced into the bag. Finally, the master bag is sealed into a closed position and placed in a cooling device for a period of time.

### PRIORITY DESIGNATION

This application claims the benefit of U.S. Provisional Application 60/303,985.

### TECHNICAL FIELD

The present invention relates to a packaging system and method of increasing the shelf-life of retail-ready meat cuts and preventing discoloration of meat products.

### BACKGROUND OF THE INVENTION

Meat production and packaging is well known in the industry. Traditionally, once a primal cut of meat has been made, it is placed in a package containing ambient air and the lidding material is fed from a roll and over the tray covering the meat cut. The tray edges are typically sealed to form the finished product. However, since the air allows the meat to become discolored due tot he onset of metmyoglobin, the meat normally undergoes vacuum skin packaging in order to maintain freshness and reduce spoilage of the meat cut. However, the vacuum packaging process normally does not allow the meat cut to exhibit a deep red pigment desired by retailers and consumers. Further, the extraction of the ambient air from the package typically results in an aesthetically unappealing and deformed shape.

Subsequently, the industry began to package meat cuts with an inert gas atmosphere after the meat has been shipped from a processing facility to a retail outlet. Thereafter, when the retail outlet receives the packaged meat, the inert gas within the package is replaced with an oxygen-containing atmosphere.

An example of such a packaging system is depicted in U.S. Pat. No. 4,055,672 issued in 1977. The '672 patent provides for a system in which a meat product is packaged within a package in which one of the package walls is formed from a gas impermeable material and another package wall is formed of an inner gas permeable layer and an outer gas impermeable layer. The meat cut is initially packaged in an inert gas atmosphere which is maintained within the package by the package walls including the outer gas impermeable wall layer. Then the outer gas impermeable layer is removed enabling the oxygen-containing ambient air to flow into the package through the gas permeable layer. However, the '672 patent allows the meat to deteriorate after the impermeable layer has been removed, unless an additional impermeable layer is added to the package. Nevertheless, placing a gas impermeable film layer over a gas permeable film layer is expensive to produce and difficult to seal to a container.

Another example of packaging containing an inert gas atmosphere is depicted in U.S. Pat. No. 6,302,324 issued in 2001. The '324 patent provides for packaging a food product in a receptacle containing an inert gas atmosphere and sealing a film to the receptacle. The receptacle includes a sealing flange and a tab portion extending from the sealing flange to which the film is sealed. The tab and the film sealed thereto are removed from the package to from an opening between the film and the receptacle when the food product is ready to be displayed to consumers. An atmosphere exchange operation is carried out through the opening, by inserting a nozzle through the opening and introducing an oxygen-containing gas into the receptacle cavity through the opening. The inert gas atmosphere initially contained within the receptacle is exhausted through the opening and the nozzle is withdrawn from the opening. The opening is closed by sealing the film to the receptacle. Here, the '324 patent allows form an inert gas atmosphere within the interior of the package to be easily and quickly replaced with an oxygen-containing atmosphere which shortens the shelf-life of a meat cut by producing a metmyoglobin effect.

U.S. Pat. No. 6,408,598 also provides for a modified atmosphere packaging process including the steps of providing a tray, providing an upper film which includes a sealant layer which is sealable to the tray, orienting the film to an orientation ratio of from about 6.0:1 about 16.0:1 positioning, a high profile product on the tray, extending the upper film above the tray and product, drawing the upper film into a concavity by differential pressure, maintaining the concave shape of the upper film while heating the film, removing gases from the space between the upper film and the tray and product, introducing a desirable gas into the space, releasing the upper film such that it shrinks toward the product and the tray while the desirable gas is retained within the space preventing close contact of the film with the lowermost portions of the product and sealing the upper film to the flange of the tray, wherein at least the step of heating the film shrinks the film, thereby tensioning it onto and across the underlying product.

meat industry to export to distant countries. Hence, the goal is to extend the shelf-life of retail-ready meat cuts.

In view of the above deficiencies associated with the abovementioned shelf-life extenders and methods, the present invention has been developed to alleviate these drawbacks and provide further benefits to the meat distribution centers, supermarkets and the consumer. These enhancement and benefits are described in greater detail hereinbelow.

### SUMMARY OF THE INVENTION

The present invention in its several disclosed embodiments alleviates the drawbacks described above with respect to traditional meat packaging and incorporates several additionally beneficial features. The process of packaging meat, namely retail-ready meat, is known in the prior art. Disclosed herein is a packaging system and method of the same developed to prevent meat discoloration of centrally prepared beef cuts, namely beef tenderloins. Specifically, each master package is sealed and back-flushed with 100% nitrogen gas thereby allowing for an extremely low concentration of oxygen to remain in the bag.

Therefore, it is an object of the present invention to provide a packaging system having an inert gas atmosphere being introduced into the interior of the package thereby reducing the amount of residual oxygen to remain therein. Further, the meat discoloration process of converting myoglobin meat pigment to metmyoglobin is prevented by the 100% nitrogen gas atmosphere being introduced to the master package. Another advantage of the present invention is to produce an aesthetically appealing package to attract consumers while displaying healthy, quality meat cuts therein. Further, the package is durable to withstand deformity during the packaging process. Additionally, the packaging system was designed to extend the shelf-life of centrally prepared retail-ready meat cuts, namely beef tenderloins.

Moreover, the master package will reduce purge due to temperature changes and will actually enhance the natural aging process producing more flavorful and tender cuts of fresh meat. Another advantage of the present invention is it increases the shelf-life in the retail case by several additional days. Since the present packaging system preserves the enzymatic activities of meat-muscle that maintains the bright cherry red color of each meat cut, the retail display life of the meat is extended dramatically.

### DESCRIPTION OF THE DRAWINGS

The invention will now be described in greater detail in the following way of example only and with reference to the attached drawings, in which:

FIG. 1 is a table depicting the retail appearance over a period of time measured in weeks.

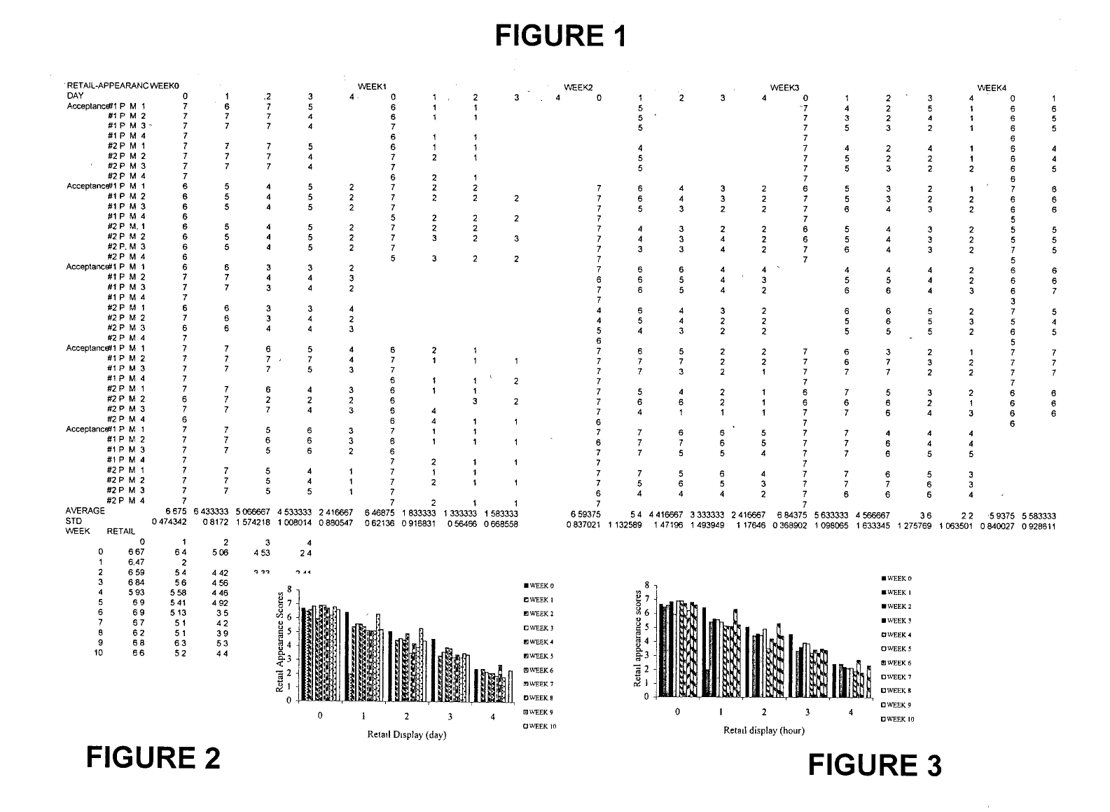

FIG. 2 is a x-y graph illustrating the retail appearance scores over a daily retail display.

FIG. 3 is ax-y graph illustrating the retail appearance scores over an hourly retail display.

FIG. 4 is a x-y graph illustrating the discoloration scores over a daily retail display.

FIG. 5 is a x-y graph illustrating the off odor intensity scores over a daily retail display.

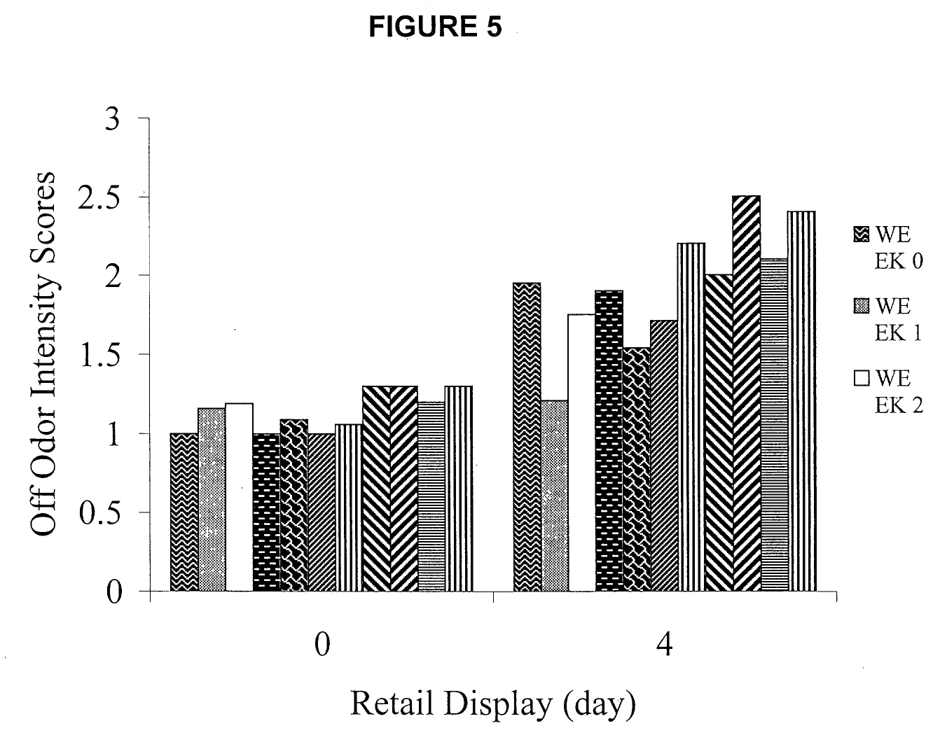

FIG. 6 is a x-y graph illustrating odor acceptability scores over a daily retail display.

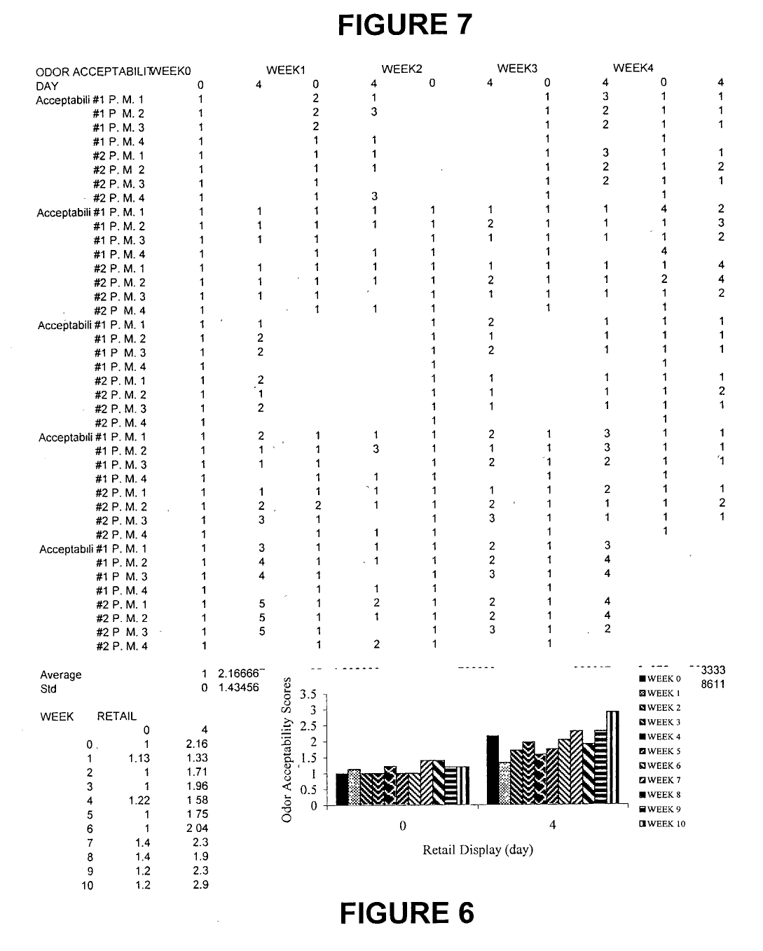

FIG. 7 is a table showing the odor acceptability scores over a weekly period of time.

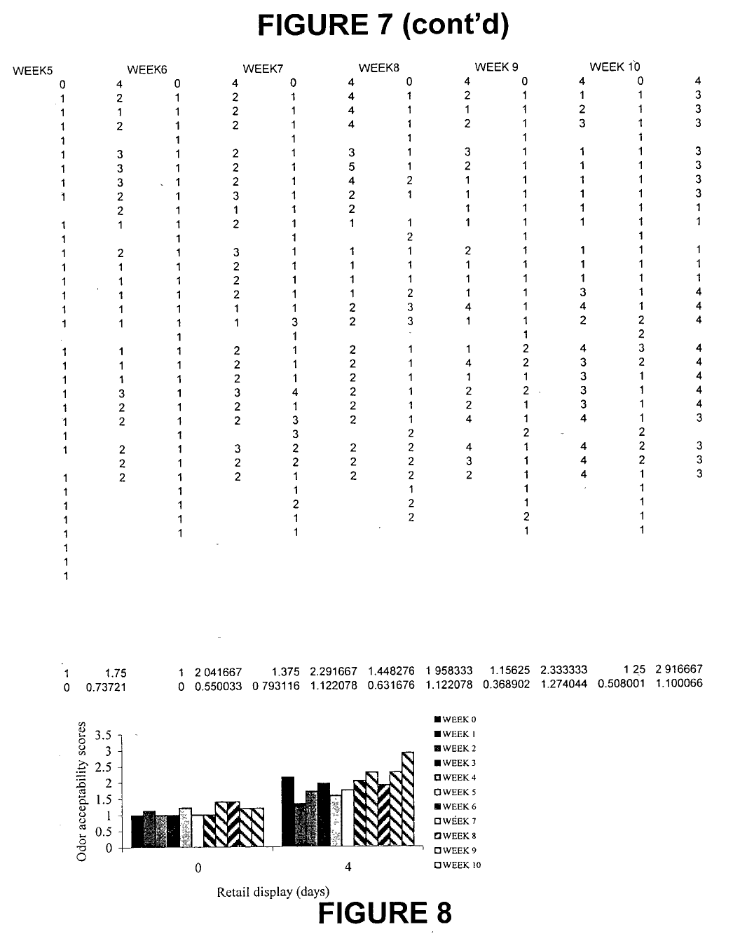

FIG. 8 is a x-y graph depicting odor acceptability scores over a daily period of time.

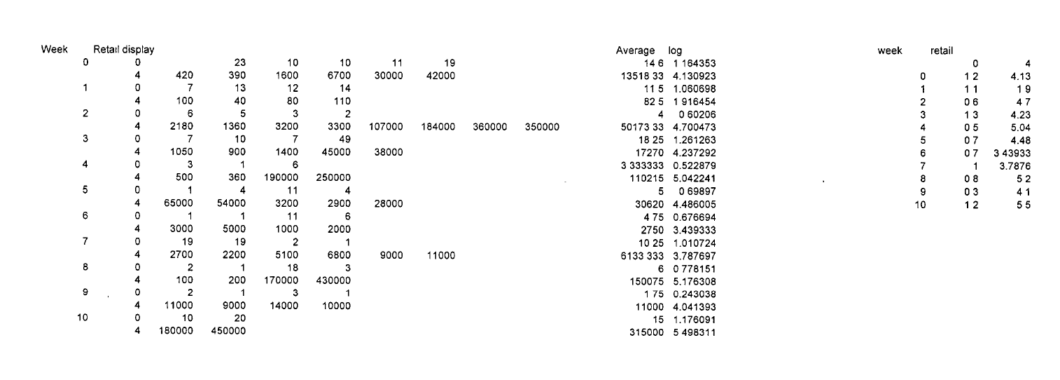

FIG. 9 is an x-y graph showing different weeks receiving color scores during retail display times as described in Example 1.

FIG. 10 is an x-y graph showing different weeks receiving discoloration scores during retail display times as described in Example 1.

FIG. 11 is an x-y graph showing different weeks receiving retail appearance scores during retail display times as described in Example 1.

FIG. 12 is an x-y graph showing different weeks receiving off odor intensity scores during a course of days of retail display as described in Example 1.

FIG. 13 is an x-y graph showing different weeks receiving odor acceptability scores during a course of days of retail display as described in Example 1.

### DETAILED DESCRIPTION OF THE PRESENT INVENTION

As required, detailed embodiments of the present invention are disclosed herein; however, it is to be understood that the disclosed embodiment(s) are merely exemplary of the invention that may be embodied in various and alternative forms. Specific structural and functional details disclosed herein are not to be interpreted as limiting, but merely as a basis for the claims and as a representative basis for teaching one skilled in the art to variously employ the present invention. Further, the particular materials and amounts thereof, as well as other conditions and details, recited in these examples should not be used to unduly limit this invention.

The present invention is a packaging system and method of the same designed to extend the shelf-life of meat cuts and prevent discoloration of centrally prepared meat cuts. The packaging process includes preparing retail meat cuts at the exact location where the animal is slaughtered. Each meat cut is positioned onto a tray and wrapped in a permeable film resulting in a prepared meat tray. Several of the prepared meat trays are preferably inserted into a master bag; in a preferred embodiment, at least four meat trays are placed into the master bag in order to increase efficiency, decrease waste and still maintain a high standard of quality. The master bag, preferably being a gas impermeable bag, is flushed back with an inert gas, preferably nitrogen gas, in order to decrease the levels of oxygen concentration within the bag. Nitrogen gas, instead of the commonly used carbon dioxide gas, prevents the meat cuts from becoming discolored. The packaging system has a storage life of at least ten weeks and a display life of at least three days.

Specifically, the method of extending shelf-life of meat includes where at least one meat cut is placed onto the tray and the film is sealed over the tray. The master bag is filled with nitrogen gas and the tray(s) is/are introduced into the bag. Finally, the master bag is sealed into a closed position and placed in a cooling device for a period of time.

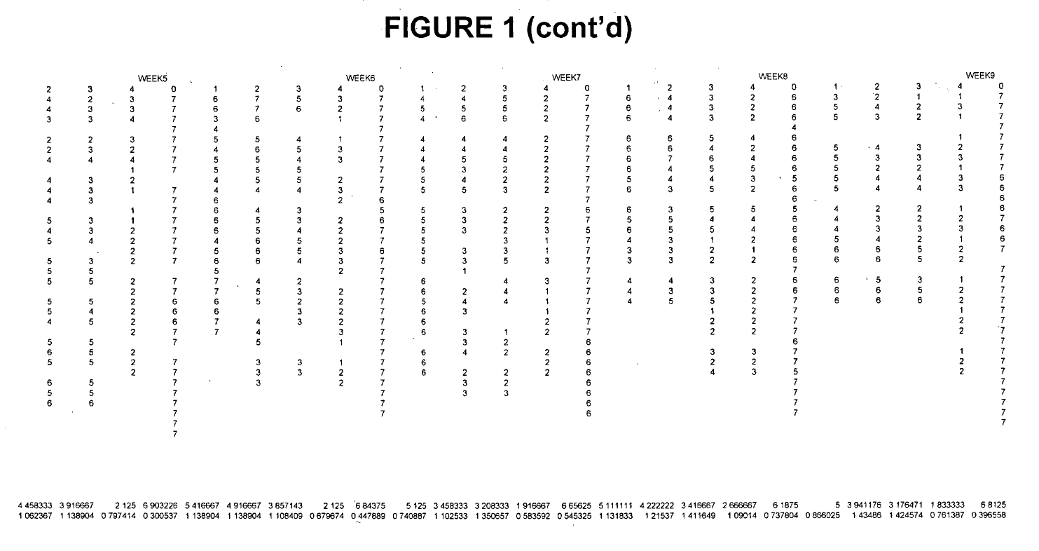

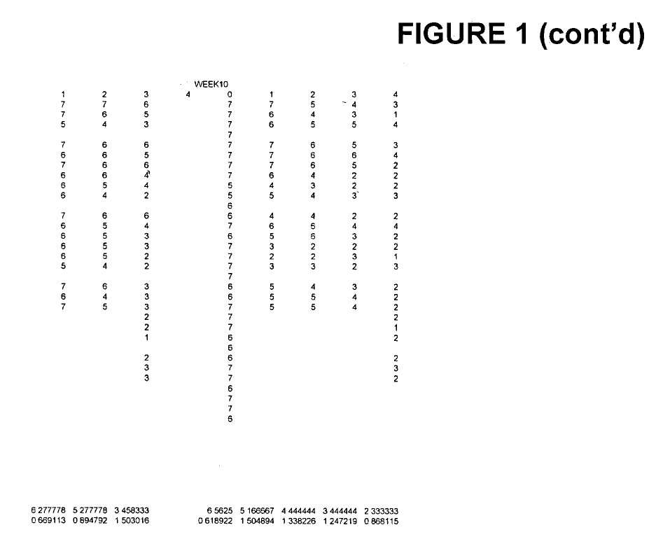

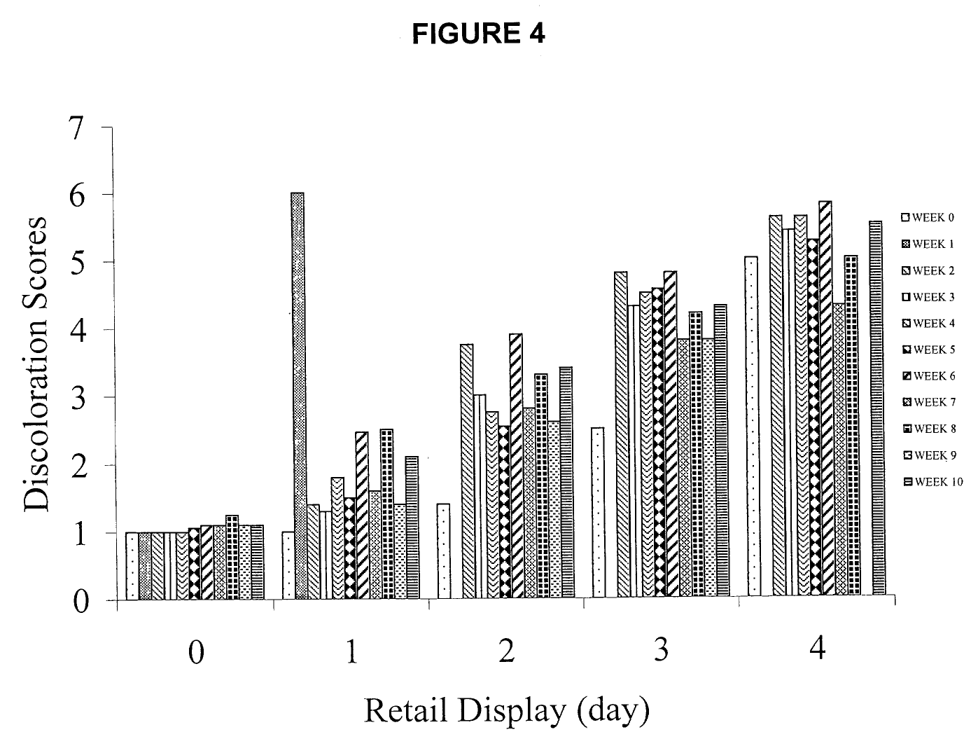

Once the meat cuts are debuted on retail display shelves, FIGS. 2 and 3 show a general decline in the retail appearance scores of the meat cuts. Specifically, the retail appearance scores have a higher rating at the display debut. However, as each hour passes the scores begin to wane; and further as each day progresses, the scores continue to decline. As the retail appearance scores decreased, the discoloration scores increased as shown in FIG. 4 whereby the myoglobin meat pigment converting to metmyoglobin increased the discoloration of the meat cut. The discoloration process along with any bacterial contamination begins to emit an odor; and the longer the meat cut is displayed, the higher the off odor intensity score becomes.

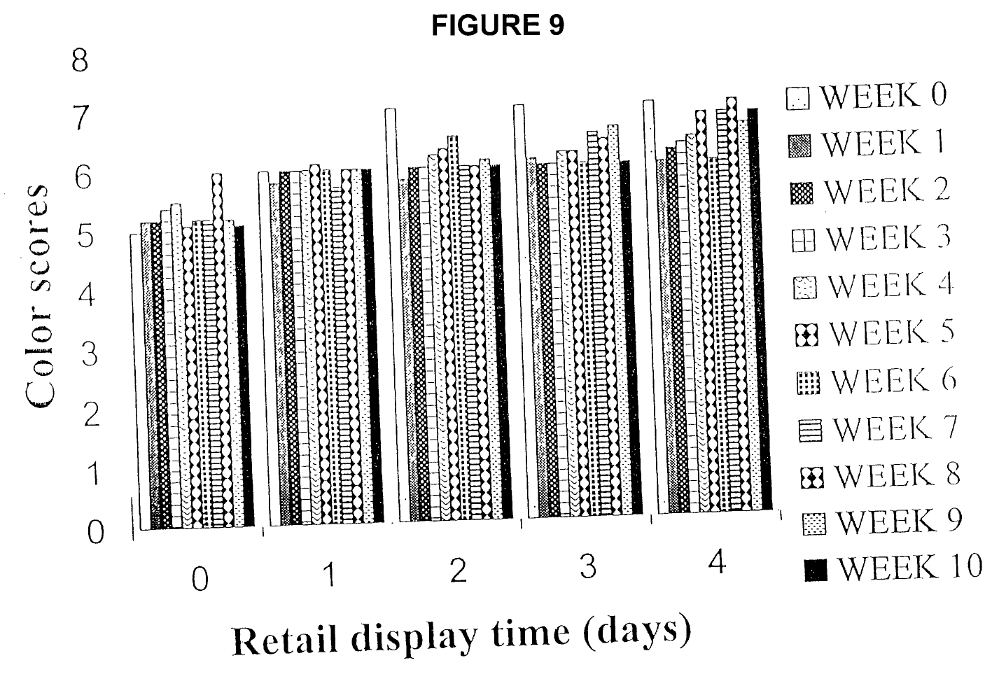

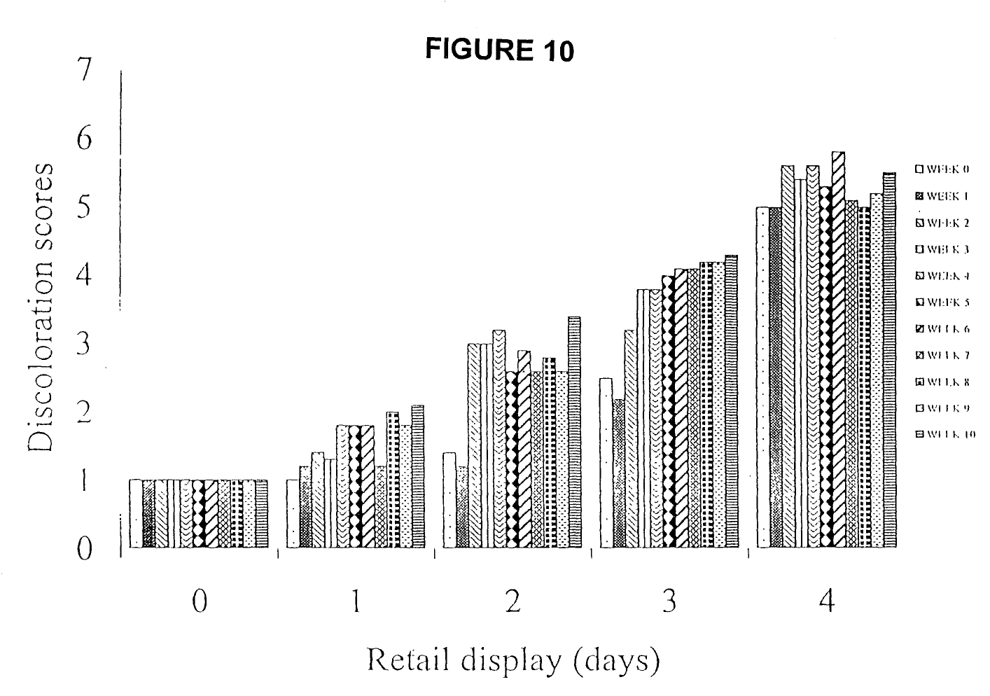

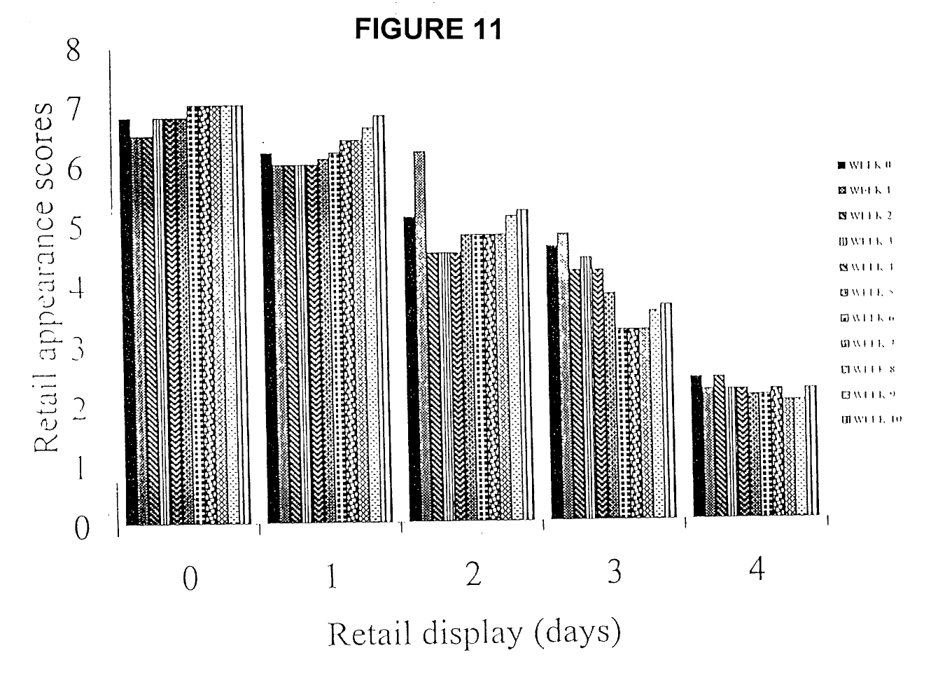

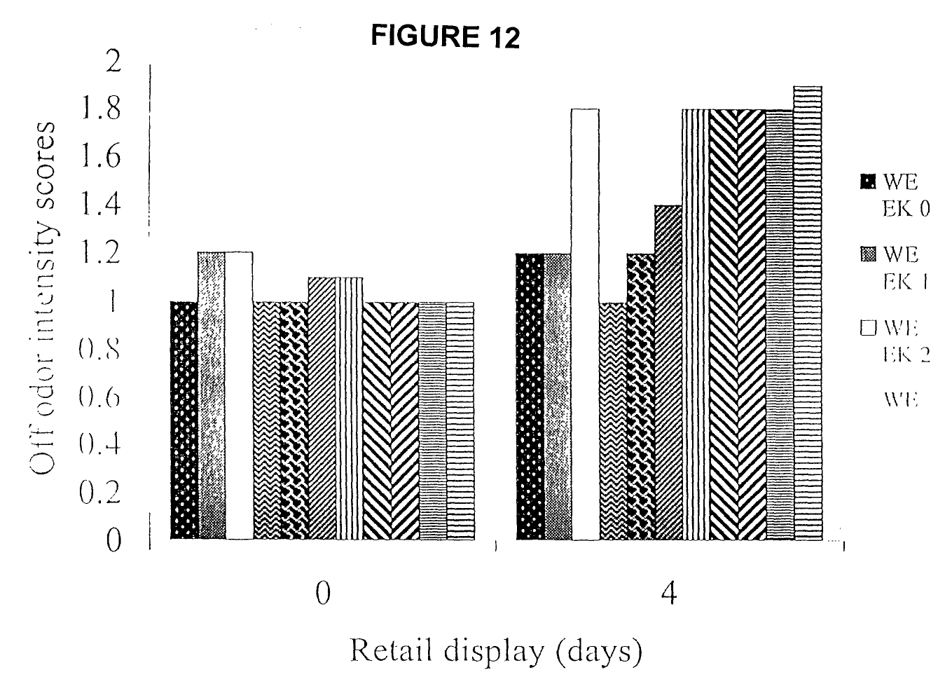

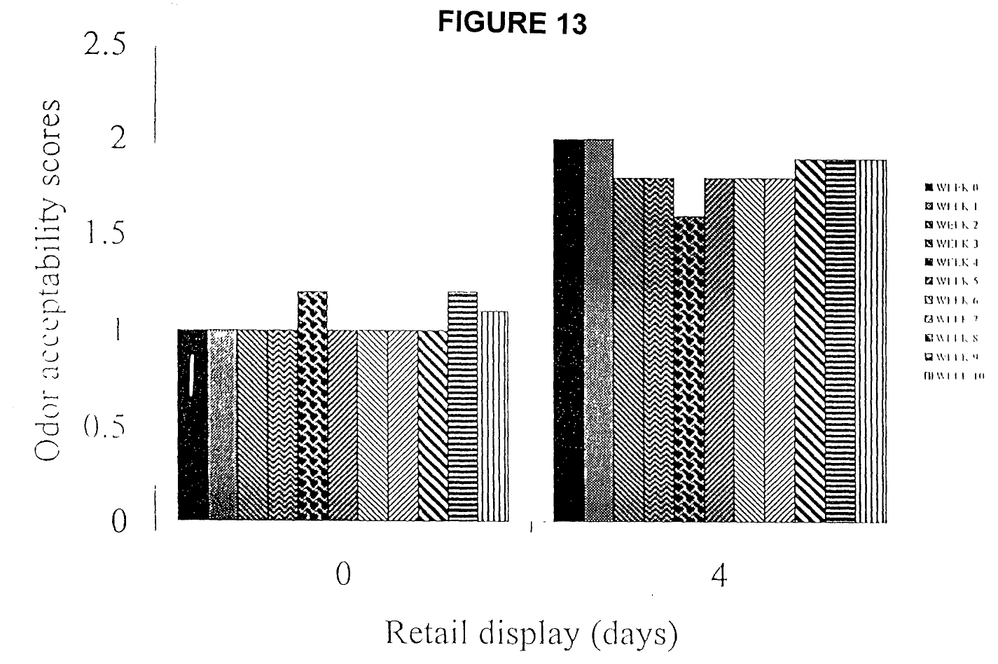

FIGS. 9-13 show the restoration of metmyoglobin reducing activity results in extending the shelf-life of retail ready meat cuts. For example, the shelf-life of the retail-ready beef tender loin cuts was ten weeks with a display life of three days after each weekly storage differing from the conventional one to two weeks with a display life of one and half days.

### EXAMPLE 1

Total Shelf Life of Retail-Ready Meat Cuts Using the Designed System Incorporating 100% Nitrogen Atmosphere

Exploration of an appropriate master-packaging system, which will minimize both color instability and microbial spoilage, is imperative for centralized meat operations. Although research has been done on microbiological and sensory aspects of meat during centralized meat packaging under various modified atmospheres, meat discoloration due to residual O₂ in controlled atmospheres remained a challenge as the rate of metmyoglobin formation increases. Beef steaks made from muscles of poor color stability such aspsoas major (PM), discolor rapidly even at O₂ concentrations of <100 ppm and sub-zero temperatures, resulting in short storage life in CAP followed by short display life. The objective of the present study was to examine the storage and retail display life of master packaged beef steaks (PM) stored under 100% nitrogen atmosphere.

Master Packaging, Storage, and Sampling of Steaks

Fresh beef tenderloins (psoas major, PM) from animals slaughtered 24 h previously, were obtained from a local beef abattoir. Eighty steaks of 2 cm thickness, were prepared from these tenderloins. Each beef cut was placed on a tray and over-wrapped with a shrinkable film. After sealing, the film was shrunk to the tray using a hot-air gun. Then, two 3-mm holes were made at the opposite comers of the tray to allow for exchange of atmospheres during gas flushing. Four such retail trays were placed in an EVA co-extruded master pack. The bags were evacuated, filled with 4.5 L of N₂, and sealed using a CAP machine where twenty such bags were prepared. Additionally, 8 retail trays were prepared and treated as un-stored controls.

The master packs were stored at −1.5±0.5° C. On week 0 and d 0 of retail display, four steaks in retail trays, serving as fresh, un-stored controls, were analyzed for visual, odor, taste, and microbial characteristics. Also, reflectance spectra were obtained from the surface of these steaks. The visual analysis was done daily for 4 d, and similarly reflectance spectra were obtained daily. On d 4 of retail display, odor, taste, and microbial analyses were done in addition to visual examination and reflectance spectra measurements. Two master packs were opened at subsequent 1 wk storage intervals for 10 wk.

Display and Sampling of Retail Trays

Upon removal from primary CAP storage at weekly intervals, and on day 0 of retail display, master packaging was removed and each group of 8 retail trays was placed in the center of the display shelf.

The displayed PM steaks were examined for color, discoloration, retail-acceptability, off odor intensity, odor acceptability, and odor description, 45 min after opening of the master-packages. Also, reflectance spectra from the steak surfaces were obtained to estimate metmyoglobin, deoxymyoglobin, and oxymyoglobin. After visual scores and reflectance spectra were obtained, two steaks (one from each master bag) were removed from the display case, and samples were taken for analysis. Then the steaks were cooked and analyzed for flavor acceptability and off-flavor intensity. The remaining six steaks were left in the display case, and were examined for visual characteristics at subsequent intervals of 24 h and reflectance spectra at 12 h for 96 h. After 96 h of retail display, the steaks were analyzed in a similar fashion as on day 0 of retail display. During sensory evaluation, the samples remained in the display case and the well-trained panelists made judgments independently. A similar procedure was repeated for all storage intervals.

Visual Assessment of Master-Packaged Steaks

A five-member panel was used for the subjective evaluation of the steaks. Color scores were assessed using an eight-point descriptive scale: 0=Completely discolored, 1=White, 2=Pale pink, 3=Pink, 4=Pale red, 5=Bright cherry red, 6=Slightly dark red, 7=Moderately dark red, 8=Extremely dark red. Surface discoloration was evaluated using a seven-point descriptive scale,: 1=0% (none), 2=1-10%, 3=11-25%, 4=26-50%, 5=51-75%, 6=76-99%, 7=100%. Retail appearance was assessed on a seven-point hedonic scale: 1=Extremely undesirable, 2=Undesirable, 3=Slightly undesirable, 4=Neither desirable nor undesirable, 5=Slightly desirable, 6=Desirable, 7=Extremely desirable.

Odor Assessments of Master-Packaged Steaks

A five-member panel was used for the odor assessment. Off odor intensity scores were assessed using a four-point descriptive scale: 1=No off odor, 2=Slight off odor, 3=Moderate off odor, 4=Prevalent off odor; odor acceptability scores were assessed using a five-point scale: 1=Acceptable, 2=Slightly acceptable, 3=Neither acceptable nor unacceptable, 4=Slightly unacceptable, 5=Unacceptable; and off odor description scores were assessed using a six-point scale: 1=Sour-sulfur rotten eggs), 2=Sour-lactic acid, 3=Putrid, 4=Dirty socks, 5=Floral/Fruity, 6=Other.

Statistical Analysis

The main effects of storage interval and retail display period were examined statistically using analysis of variance (proc ANOVA, SAS Institute Inc., Cary, N.C.) at an a level of 0.05.

Results

Evaluation of Steaks

Although significant (p<0.05) differences existed between CAP storage intervals in visual color rating on d 0 of retail display, that is, when steaks were removed from storage, all steaks were perceived to be bright cherry red or slightly dark red and no differences of practical importance existed. Generally, steaks remained stable in color until they became extremely dark or completely discolored (data not shown) on the fourth day of retail display for any storage interval. Due to leak in the master pack, steaks were completely discolored on d 1 of retail display after 1 wk of storage. These steaks were removed from retail display and not analyzed further.

On d 0 of retail display for any CAP storage interval, no significant (p>0.05) surface discoloration was reported on the steaks. The retail display period significantly (p<0.05) increased the amount of surface discoloration on the steaks for any CAP storage interval. However, the steaks discolored at a faster rate than the un-stored controls for all storage intervals, and were relatively extensively discolored (p<0.05). Steaks were extremely desirable in retail appearance on d 0 of retail display for any storage interval (p>0.05). Despite the fact that they deteriorated more rapidly in retail appearance than the un-stored controls, they were still in the acceptable range (about 3.5) on the third day of retail display.

From a practical perspective, steaks were perceived to have no off-odors on d 0 of retail display for any storage interval, however, significant differences existed between storage intervals with respect to off odor intensity ratings (p<0.05). The maximum difference in ratings was 0.3 of a panel unit, which is of marginal practical importance. Even on d 4 of retail display, only slight off-odors were reported. Generally, odor of steaks was acceptable on day 0 of retail display. Maximum differences of 0.3 of a panel unit were noticed after 7 and 8 wk of CAP storage, which has little practical significance. Despite significant (p<0.05) differences between storage intervals on odor acceptability ratings of d 4 of retail display, all steaks were perceived to be slightly acceptable.

Despite differences (p<0.05) between CAP storage intervals on microbial numbers at d 0 of retail display, steaks had <10² cfu/cm² of total organisms, and no differences of practical importance existed. In most cases, microbial numbers were comparable with those of un-stored controls. On d 4 of retail display, microbial numbers were <10⁰ cfu/cm² in all cases.

Discussion

Centrally prepared retail beef cuts stored in controlled atmospheres containing nearly 100% carbon dioxide (CO₂) or nitrogen (N₂) which may have small amounts of O₂ are susceptible to the formation of metmyoglobin, due to the presence of residual O₂. It is reported that in packaged fresh beef 2-4 d are required for reduction of metmyoglobin to deoxymyoglobin. When stored meat is removed from the controlled atmosphere, it blooms to the desirable, bright red color associated with freshly cut meat, but this will not occur if a substantial amount of metmyoglobin is present. The MRA of muscle tissue is limited in stability and once exhausted is not available to convert metmyoglobin back to myoglobin. To overcome this disadvantage and address the issue of transient discoloration during CAP storage of fresh beef, the present work was undertaken to combine the efficacies of CAP storage of fresh beef, the present work was undertaken to combine the efficacies of CAP storage and demonstrate the shelf life extension of retail-ready fresh beef under these conditions. Tenderloins are known to have very poor color stability and discolor rapidly even at very low O₂ concentrations and at a storage temperature of −1.5±0.5° C. The effect of inter-muscular differences on color stability adds another variable that complicates continuous prevention of meat discoloration. Biochemical factors, such as oxygen consumption rate (OCR) and MRA, have been reported to be different for different muscles. Therefore, the system was tested using a beef muscle type that had poor color stability and represented a worst-case challenge for centralized meat operations.

For all CAP storage intervals, the steaks had acceptable visual, odor, and flavor scores on day 0 of retail display. Additionally, metmyoglobin content was minimal, and in some cases even lower than in fresh controls on the day packs were opened and displayed. Beef tenderloins were used in the study, and these muscles are internally located and do not undergo much handling by meat-cutters as compared to other cuts. This procedure protects them to some extent from cross-contamination, and hence yields low initial microbial load. The meat cuts used in the present study had very low initial microbial numbers, which would have delayed onset of spoilage levels of microorganisms, and thus may have reduced the occurrence of off-odors. It was not surprising that microbial growth and odor did not limit CAP storage and retail display life of steaks.

Due to maximal metmyoglobin formation at sub-zero temperatures, maximum discoloration occurred several millimeters below the meat surface. Since meat is translucent, such discoloration is normally visible. The deeper in the tissue metmyoglobin occurs, the lower its visibility becomes, and this resulted in low levels of discernable discoloration and higher retail appearance scores during retail display. Prevention of such transient discoloration has been reported above. The combination of these hurdles resulted in reduced discoloration even on d 3 of the retail display period. Since the bright-red color of meat was restored, the steaks received acceptable retail appearance scores on d 3 of retail display for any CAP storage interval, after which the meat was in an unacceptable range. Thus, visual characteristics seem to be the limiting factor for acceptability of steaks. Steaks had a slight off-flavor on d 0 of retail display after 8 wk CAP storage and onwards. Considering the intrinsic variability in meat cuts, such slight deterioration of flavor and odor may be of no practical importance.

The relative success of the system used in the present study is noteworthy considering the poor color stability of PM muscle. The system is able to deliver longer CAP storage with longer subsequent retail display life if beef muscles with higher color stability are used. It can be conservatively concluded that the present system has the capability of providing a 10 week CAP storage life with a subsequent 3 day retail display life for centrally prepared beef tenderloin steaks.

These results demonstrate the following principles:

1. Metmyoglobin reducing activity is capable of being restored within a few hours of sealing the package.

2. The permeability of packaging films having very high oxygen ingress rate is significantly reduced at sub-zero temperatures where the films act as an oxygen barrier.

Included within the scope of the present invention and the abovementioned examples are compositions comprising various combinations of these substances and materials. Aspects of the present invention have ben described by way of example only and it should be appreciated that modifications and additions may be made thereto without departing from the scope thereof.

Industrial Applicability:

The present invention finds specific industrial applicability in the food distribution and retail industries.

What is claimed and desired to be secured by Letters Patent is as follows:

1. A packaging system adapted to extend shelf-life of meat comprising:
a tray; and
a master bag being back-flushed with nitrogen gas and housing said tray therein.

2. The packaging system as recited in claim 1, wherein said master bag is filled with 100% of said nitrogen gas.

3. The packaging system as recited in claim 1, wherein said master bag is capable of housing multiple trays therein.

4. The packaging system as recited in claim 1, wherein said packaging system has at least a ten week storage life.

5. The packaging system as recited in claim 4, wherein said packaging system further comprises a display life of at least three days.

6. The packaging system as recited in claim 1, wherein said master bag is a gas-impermeable bag.

7. The packaging system as recited in claim 1, further comprising a permeable film operatively surrounding said tray.

8. The packaging system as recited in claim 7, wherein said film has a high oxygen permeability.

9. A method of extending shelf-life of meat comprising the steps of:
placing at least one cut of meat onto a tray having an activated oxygen scavenger and an absorbent pad;
arranging and sealing a permeable film over said tray thereby housing said cut of meat therein;
filling a master bag with nitrogen gas;
inserting at least one of said trays into said master bag; and
sealing said master bag into a closed position.

10. The method as recited in claim 9, further comprising the step of:
placing said master bag into a cooler for a determined period of time.
